(19) United States
(12) Patent Application Publication
(10) Pub. No.: US 2012/0092322 A1
(43) Pub. Date: Apr. 19, 2012

(54) LIQUID CRYSTAL DISPLAY DRIVE CIRCUIT AND METHOD FOR DRIVING SAME

(75) Inventors: Hiroyasu ENJOU, Kanagawa (JP); Hirokazu KAWAGOSHI, Kanagawa (JP)

(73) Assignee: RENESAS ELECTRONICS CORPORATION, Kanagawa (JP)

(21) Appl. No.: 13/267,629

(22) Filed: Oct. 6, 2011

(30) Foreign Application Priority Data
Oct. 19, 2010 (JP) 2010-234969

(51) Int. Cl. G09G 5/00; G09G 3/36

(52) U.S. Cl. 345/211; 345/98

(57) ABSTRACT

A liquid crystal display drive circuit includes first and second buffer circuits, first to fourth switches, and a control signal generation circuit (CSGC). The first buffer circuit drives a first or second data line, and the second buffer circuit drives the second or first data line. Closing the first switch makes the first buffer circuit drive the first data line responsive to a first control signal. Closing the second switch makes the second buffer circuit drive the second data line. Closing the third switch makes the first buffer circuit drive the second data line in responsive to a second control signal. Closing the fourth switch is makes the second buffer circuit drive the first data line. The CSGC generates the first-third control signals for causing respective outputs of the first buffer circuit, and the second buffer circuit to be in high impedance state on the basis of a strobe signal.

### CROSS-REFERENCE TO RELATED APPLICATIONS

The disclosure of Japanese Patent Application No. 2010-234969 filed on Oct. 19, 2010, including the specification, drawings and abstract, is incorporated herein by reference in its entirety.

### BACKGROUND

The present invention relates to a liquid crystal display drive circuit, and a method for driving the same.

There has since been further increase in importance of a flat display device such as a liquid crystal display, and so forth, following recent progresses made in sophisticated visualized and computerized society, and widespread use of multimedia systems. As the liquid crystal display has points in its favor from the viewpoint of low power consumption, low profile style, light weight, and so forth, the liquid crystal display has been in widespread use as a display of portable terminal equipment.

The liquid crystal display comprises a liquid crystal panel for executing image display, and a drive circuit for driving the liquid crystal panel (a scan line drive circuit: a gate driver, a data line drive circuit: a source driver). For reasons of reduction in power consumption of the data line drive circuit (the source driver), countermeasures against radiation noise (EMI), enhancement in through rate, and so forth, adoption of a charge-sharing technology has become part of the mainstream.

Japanese Unexamined Patent Publication No. 2007-052396 has disclosed a technology related to a drive circuit of a liquid crystal display using the charge-sharing technology. FIG. 1 is a schematic block diagram showing a configuration of the liquid crystal display. The liquid crystal display is comprised of a liquid crystal panel 300 where TFTs (Thin Film Transistors) 312, and liquid crystal capacitors 314 are disposed in a matrix-like manner, a scan line drive circuit 200 for driving scan lines 280 of the liquid crystal panel 300, and a data line drive circuit 400 for driving data lines of the liquid crystal panel 300. The data line drive circuit 400 comprises a positive gradation voltage generation circuit 401, a negative gradation voltage generation circuit 402, positive DA conversion circuit 405P for DA conversion of the gradation voltage generated by the positive gradation voltage generation circuit 401, a negative DA conversion circuit 405M for DA conversion of the gradation voltage generated by the negative gradation voltage generation circuit 402, a buffer unit 410, a switching unit 420, and an output short circuit unit 430.

DA-converted signals are subjected to buffering at the buffer unit 410, and a positive signal and a negative signal are switched at the switching unit 420. An even data line 480, and an odd data line 481 adjacent thereto are shorted to each other at the output short circuit unit 430. Further, the even data line 480, and the odd data line 481, shorted to each other, are coupled to a common node 428 via a common node connection switch 426, whereupon the even data line 480, and the odd data line 481 are at an identical voltage.

In FIG. 2, there is shown a circuit diagram showing a part of the data line drive circuit 400, related to a pair of data lines from the DA conversion circuits 405P, 405M to an output. A circuit for driving a pair of the even data line 480, and the odd data line 481 includes the positive DA conversion circuit 405P, the negative DA conversion circuit 405M, a positive buffer circuit 411P, a negative buffer circuit 411M, straight switches 421, 422, cross switches 423, 424, and a short circuit switch 425 (in FIG. 2, the common node 428, and the common node connection switch 426 are not shown).

The data line drive circuit 400 adopts a two-amp scheme for driving a pair of data lines by switching over between two buffer circuits. Switching in polarity is executed by the four switches (421, 422, 423, 424). The straight switches 421, 422 are identical in phase to turn into the on state (closed state) such that the buffer circuit 411P drives the odd data line 481, and the buffer circuit 411M drives an even data line 480. The cross switches 423, 424 are identical in phase to turn into the on state (closed state) such that the buffer circuit 411P drives the even data line 480, and the buffer circuit 411M drives the odd data line 481. Accordingly, the straight switches 421, 422 are activated in a phase opposite to that of the cross switches 423, 424.

As shown in FIGS. 3A to 3F, a charge-sharing operation is executed at the time of switchover in polarity. A control signal for activating the respective switches is changed over by use of a strobe signal STB as a timing reference for a display action (FIG. 3A). A control signal SST for turning the straight switches 421, 422 on/off, and a control signal SCR for turning the cross switches 423, 424 on/off are alternately turned on in sync with the falling edge of the strobe signal STB, and alternately turned off in sync with the rising edge of the strobe signal STB (FIGS. 3B and 3C). During a period when the strobe signal STB is at high level, the short circuit switch 425, and the common node connection switch 426 are closed, whereupon charge-sharing is executed (FIGS. 3C, 3D, 3E). That is, during the period when the strobe signal STB is at high level, the switches 421 to 424 are in the open state, and the switches 425, 426 are in the closed state, whereupon the charge-sharing operation is executed (FIGS. 3D and 3E).

In the charge-sharing operation, the short circuit switch 425 has to reduce on-resistance to some extent in order to cause the voltage of the respective even data lines 480 to be equal to that of the respective odd data lines 481 in a short time, so that there will be an increase in area of a transistor serving as the switch. More specifically, in order to effect the charge-sharing operation, there will arise the needs for the short circuit switch 425 that is small in on-resistance. The short circuit switch 425 is positioned between each of the even data lines 480, and each of the odd data lines 481, so that an increase in chip size will result.

### SUMMARY

It is an object of the invention to provide a liquid crystal display drive circuit capable of executing a charge-sharing operation without causing an increase in chip size, and a method for driving the same.

There are described hereinafter means for solving a problem with reference to numerals and signs used under DETAILED DESCRIPTION. These numerals and signs are provided in order to clarify a corresponding relationship between description of the appended claims, and DETAILED DESCRIPTION. However, it is to be pointed out that those numerals and signs be not used in interpretation of a technical scope of the invention, described in the appended claims.

In accordance with one aspect of the invention, there is provided a liquid crystal display drive circuit comprising first and second buffer circuits (111P, 111M), first to fourth switches (121 to 124), and a control signal generation circuit (500). The first buffer circuit (111P) drives a first data line (181), or a second data line (182) adjacent to the first buffer circuit. The second buffer circuit (111M) drives the second data line (182), or the first data line (181). The first switch (121) is closed so as to cause the first buffer circuit (111P) to drive the first data line (181) in response to a first control signal (SSA) generated on the basis of a strobe signal (STB) for indicating a timing reference for a display action. The second switch is closed so as to cause the second buffer circuit (111M) to drive the second data line (182) in response to the first control signal (SSA). The third switch (123) is closed so as to cause the first buffer circuit (111P) to drive the second data line (182) in response to a second control signal (SSB) generated on the basis of the strobe signal (STB). The fourth switch (124) is closed so as to cause the second buffer circuit (111M) to drive the first data line (181) in response to the second control signal (SSB). The control signal generation circuit 500 generates the first and second control signals (SSA, SSB), and a third control signal (SSC, SSD) for causing respective outputs of the first buffer circuit, and the second buffer circuit to be in a high impedance state on the basis of the strobe signal (STB).

According to another aspect of the invention, there is provided a method for driving a liquid crystal display, which includes the steps of (a) coupling an output of a first buffer circuit (111P) to a first data line (181), and coupling an output of a second buffer circuit (111M) to a second data line (182) in response to a first control signal (SSA), (b) coupling the output of the first buffer circuit (111P) to the second data line (182), and coupling the output of the second buffer circuit (111M) to the first data line (181) in response to a second control signal (SSB); and (c) causing the respective outputs of the first and the second buffer circuits to be turned into high impedance state when the respective outputs of the first and second buffer circuits (111P, 111M) are coupled to both the first and second data lines (181, 182), and there is executed a charge-sharing operation whereby the respective voltages of the first and second data lines, adjacent to each other, are at a common voltage when the respective outputs of the first and second buffer circuits are in the high impedance state.

According to the aspects of the present invention, there can be provided a liquid crystal display drive circuit capable of executing a charge-sharing operation without causing an increase in chip size, and a method for driving the same.

### BRIEF DESCRIPTION OF THE DRAWINGS

FIG. 1 is a block diagram showing a configuration of a liquid crystal display;

FIG. 2 is a schematic representation showing a signal path from respective DA conversion circuits of a data line drive circuit to respective display panel loads;

FIGS. 3A to 3F each are a timing chart for describing actions of respective switches;

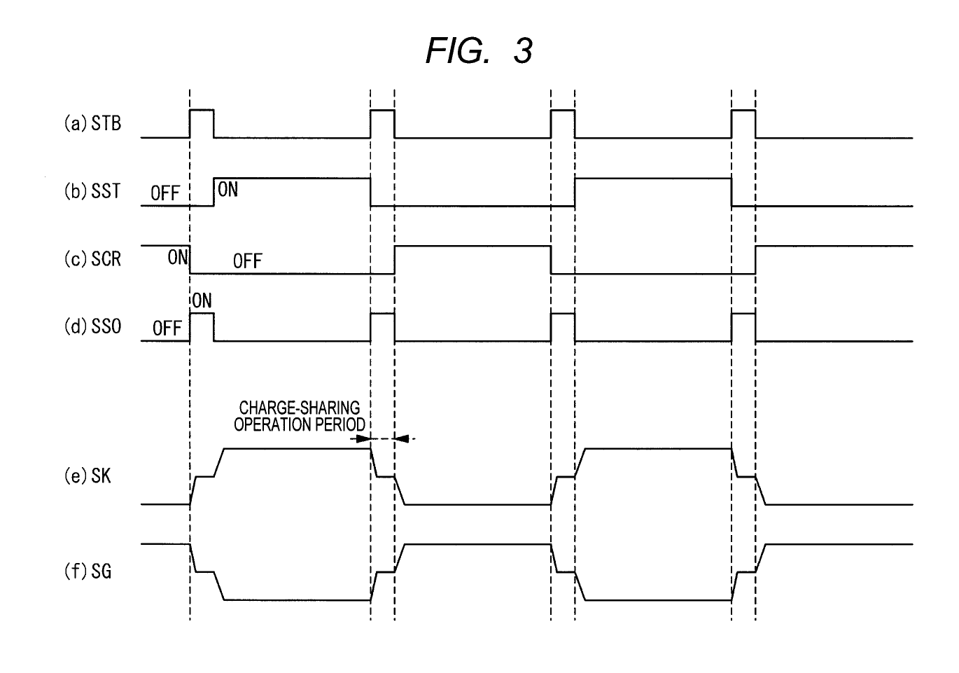

FIG. 4 is a block diagram showing a configuration of a liquid crystal display according to one embodiment of the invention by way of example;

FIG. 5 is a schematic representation showing a signal path from respective DA conversion circuits of a data line drive circuit according to the embodiment of the invention to respective display panel loads;

FIG. 6 is a circuit diagram showing a configuration of a buffer circuit according to the embodiment of the invention by way of example; and

FIGS. 7A to 7G each are a timing chart for describing actions of respective switches according to the embodiment of the invention.

### DETAILED DESCRIPTION

An embodiment of the invention is described hereinafter with reference to the accompanying drawings.

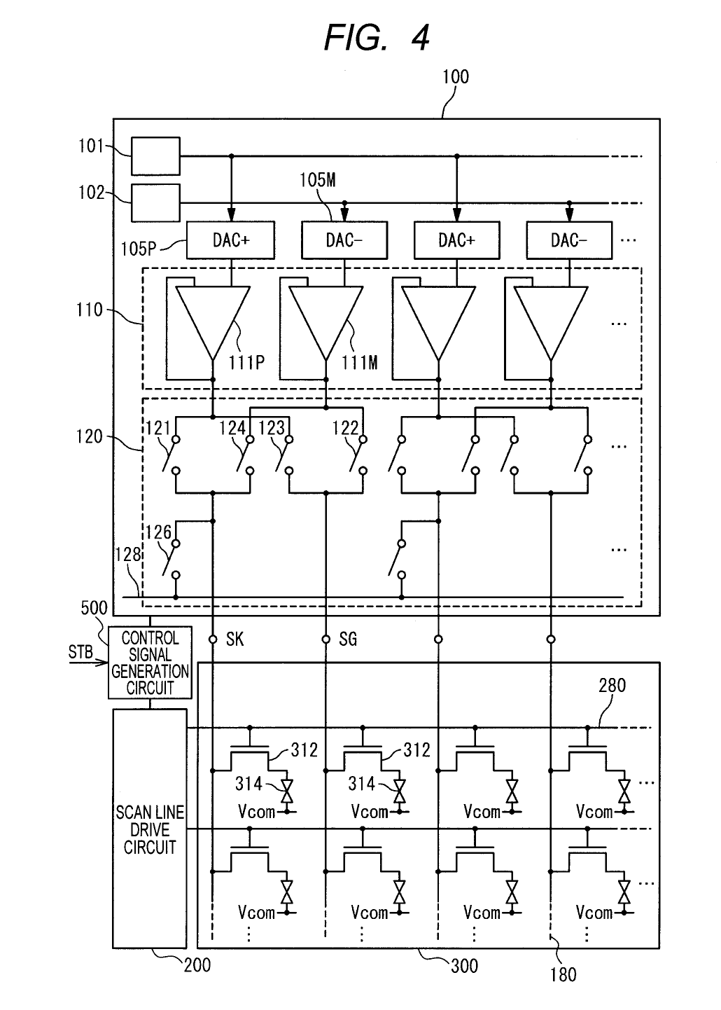

FIG. 4 is a block diagram showing a configuration of a liquid crystal display related to the embodiment of the invention. The liquid crystal display comprises a liquid crystal panel 300 where TFTs (Thin Film Transistors) 312, and liquid crystal capacitors 314 are disposed in a matrix-like manner, a scan line drive circuit 200 for driving scan lines 280 of the liquid crystal panel 300, a data line drive circuit 100 for driving data lines 180 of the liquid crystal panel 300, and a control signal generation circuit 500.

The control signal generation circuit 500 supplies the data line drive circuit 100, and the scan line drive circuit 200 with a control signal for indicating activation timing of respective switches on the basis of a strobe signal STB for indicating a timing reference for a display action.

An odd data line 181 and an even data line 182 in pairs are controlled on the basis of the order in which the data lines 180 are arranged. More specifically, the data line drive circuit 100 of the two-amp scheme is comprised a positive gradation voltage generation circuit 101, a negative gradation voltage generation circuit 102, a positive DA conversion circuit 105P for DA conversion of a gradation voltage generated by the positive gradation voltage generation circuit 101, a negative DA conversion circuit 105M for DA conversion of a gradation voltage generated by the negative gradation voltage generation circuit 102, a buffer unit 110, and a switching unit 120.

DA-converted signals are subjected to buffering at the buffer unit 110, and a positive signal and a negative signal are switched over at the switching unit 120. Further, the respective data lines 180 are coupled to a common node 128 via a common node connection switch 126 to be at an identical voltage. In this case, the common node connection switch 126 is coupled to the odd data line 181; however, the common node connection switch 126 may be coupled to the even data line 182, or all the data lines 180.

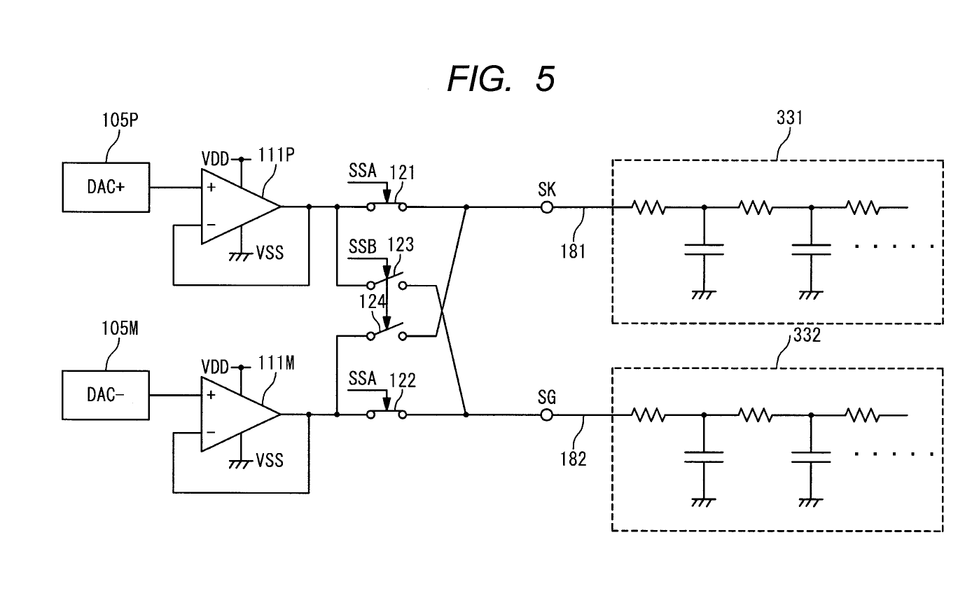

In FIG. 5, there is shown a circuit diagram showing a part of the data line drive circuit 100, related to a pair of the data lines from the DA conversion circuits 105P, 105M to an output. A circuit for driving a pair of the data lines 181, 182 includes the positive DA conversion circuit 105P, the negative DA conversion circuit 105M, a positive buffer circuit 111P, a negative buffer circuit 111M, straight switches 121, 122, and cross switches 123, 124, (in FIG. 5, the common node 128 and the common node connection switch 126 are not shown).

The data line drive circuit 100 adopts the two-amp scheme for driving data lines by switching over between two buffer circuits. Switching in polarity is executed by the four switches (121, 122, 123, 124). The straight switches 121, 122 each are activated on the basis of the control signal SSA supplied from the control signal generation circuit 500 such that the buffer circuit 111P drives the odd data line 181, and the buffer circuit 111M drives the even data line 182. The cross switches 123, 124 each are activated on the basis of the control signal SSB supplied from the control signal generation circuit 500 such that the buffer circuit 111P drives the even data line 182, and the buffer circuit 111M drives the odd data line 181. Accordingly, when the straight switches 121, 122 are closed concurrently with the cross switches 123, 124, the odd data line 181 is shorted to the even data line 182. The odd data line 181 drives a display panel load 331 via an odd output node SK, and the even data line 182 drives a display panel load 332 via an even output node SG.

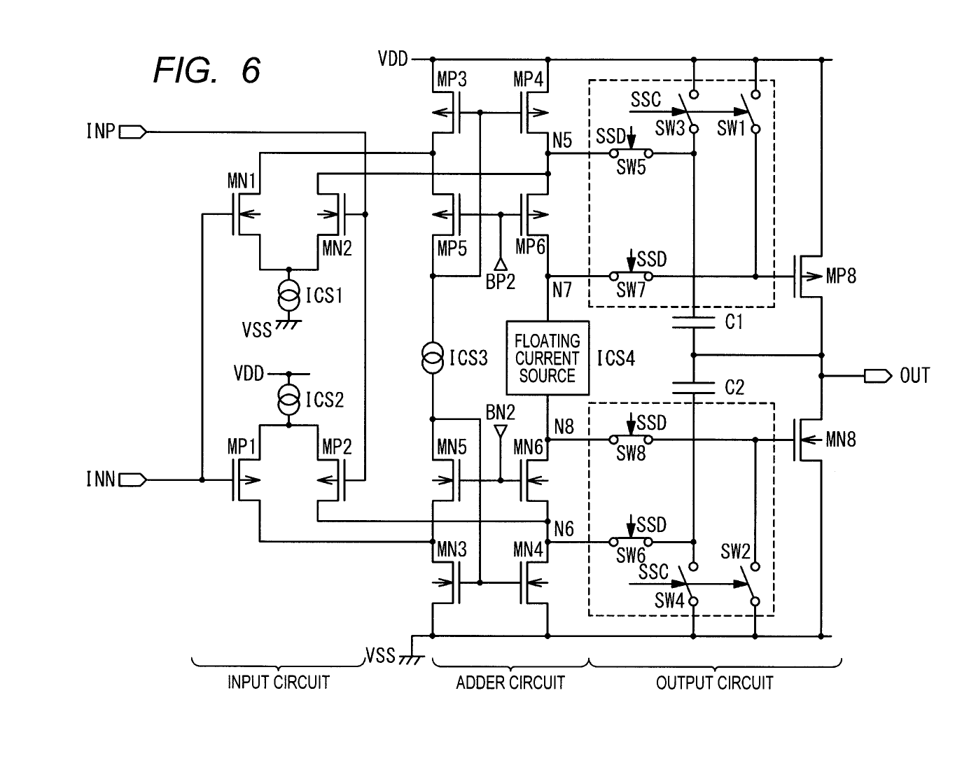

As shown in FIG. 6, the buffer circuit 111 of the buffer unit 110 (in this case, the buffer circuit 111 is described on the assumption that the buffer circuit 111P is identical in circuit configuration to the buffer circuit 111M) is comprised of an input circuit, an adder circuit, and an output circuit. The input circuit comprises complementary two differential amplifiers for receiving differential signals inputted from input nodes INP, INN, respectively. A first differential amplifier includes transistors MN1, MN2, and a constant current source ICS1, and a second differential amplifier includes transistors MP1, MP2, and a constant current source ICS2.

The adder circuit comprises two current mirror circuits, a constant current source ICS3, and a floating current source ICS4. A first current mirror circuit coupled to the first differential amplifier is comprised of transistors MP3 to MP6, and a second current mirror circuit coupled to the second differential amplifier is comprised of transistors MN3 to MN6. The constant current source ICS3 is coupled between the first current mirror circuit, and the second current mirror circuit. The floating current source ICS4 for execution of an AB-class bias control is coupled between the respective output sides of the first current mirror circuit, and the second current mirror circuit. A bias voltage BP2 is applied to respective gates of the transistors MP5, MP6, and a bias voltage BN2 is applied to respective gates of the transistors MN5, MN6.

The output circuit is comprised of output transistors MP8, MN8, phase compensation capacitors C1, C2, and switches SW1 to SW8. The output transistors MP8, MN8 are coupled in series between power supply voltages VDD, VSS. A gate of the output transistor MP8 is coupled to the power supply voltage VDD via the switch SW1, and is coupled to a node N7 between the transistor MP6, and the floating current source ICS4 via the switch SW7. The switch SW1 and the switch SW7 change over coupling of the gate of the output transistor MP8 to the node N7 of the adder circuit, or to the power supply voltage VDD. When the gate of the output transistor MP8 is coupled to the power supply voltage VDD, the output transistor MP8 is turned off. Further, a gate of the output transistor MN8 is coupled to the power supply voltage VSS via the switch SW2, and is coupled to a node N8 between the transistor MN6 and the floating current source ICS4 via the switch SW8. The switch SW2 and the switch SW8 change over coupling of the gate of the output transistor MN8 to the node N8 of the adder circuit, or to the power supply voltage VSS. When the gate of the output transistor MN8 is coupled to the power supply voltage VSS, the output transistor MN8 is turned off.

A coupling node between a drain of the output transistor MP8 and a drain of the output transistor MN8 is an output node OUT of the buffer circuit 111. The phase compensation capacitor C1 is inserted between a coupling node N5 between the transistors MP4, MP6, and the output node OUT. The phase compensation capacitor C1 is coupled to the coupling node N5 via the switch SW5, and is further coupled to the power supply voltage VDD via the switch SW3. The phase compensation capacitor C2 is inserted between a coupling node N6 between the transistors MN4, MN6, and the output node OUT. The phase compensation capacitor C2 is coupled to the coupling node N6 via the switch SW6, and is further coupled to the power supply voltage VSS via the switch SW4.

The switches SW1 to SW8 are controlled on the basis of the strobe signal STB. The switches SW1 to SW4 are each activated on the basis of a control signal SSC supplied from the control signal generation circuit 500, and when the strobe signal STB is at high level, the switches SW1 to SW4 open the circuit. The switches SW5 to SW8 are each activated on the basis of a control signal SSD supplied from the control signal generation circuit 500, and when the strobe signal STB is at high level, the switches SW5 to SW8 close the circuit. For each of the switches SW1 to SW8, through which a large current does not flow, use can be made of a small transistor. Thus, the buffer circuit 111 is capable of keeping the output thereof in a high impedance state by the agency of the switches SW1 to SW8 on the basis of the strobe signal STB, thereby holding the output node OUT at an intermediate voltage between the power supply voltages VDD, VSS.

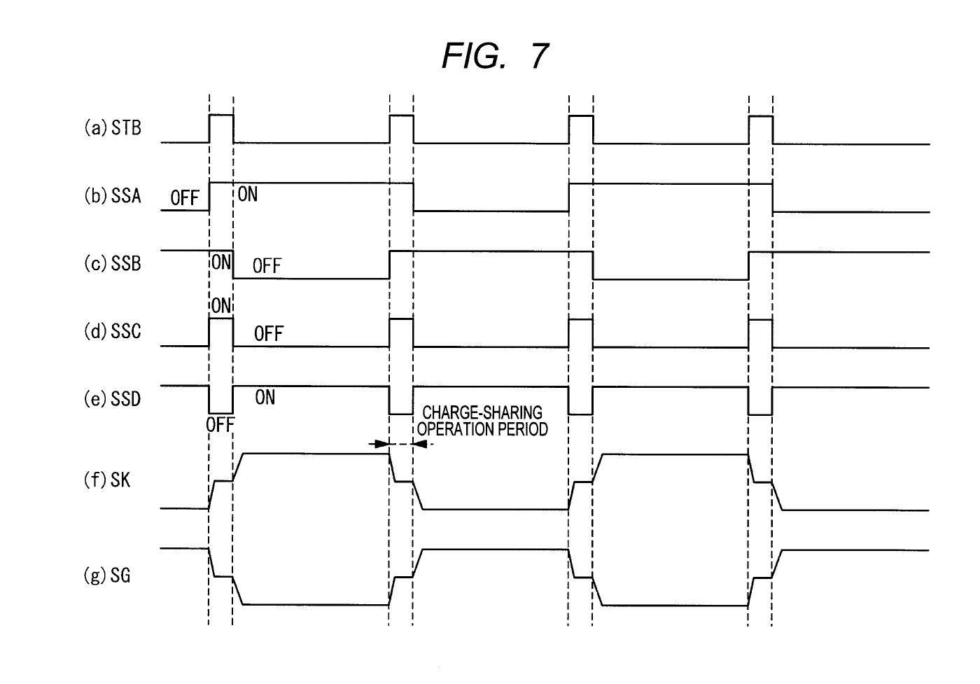

FIGS. 7A to 7G are a timing chart showing an operation of the data line drive circuit 100. The strobe signal STB is a signal for indicating a timing reference of a display action, as shown in FIG. 7A. As shown FIG. 7B, the control signal SSA is at high level such that the straight switches 121, 122 are closed (in the on state) during a period corresponding to one cycle of the strobe signal STB, and a period during which the strobe signal STB is at high level. As shown FIG. 7C, the control signal SSB is at high level such that the cross switches 123, 124 are closed during a period corresponding to one cycle of the strobe signal STB, and a period during which the strobe signal STB is at a high level. More specifically, the control signals SSA, SSB are at high level during the interval when the strobe signal STB is at high level, so that all the switches 121 to 124 are in the closed state.

As shown in FIG. 7D, the control signal SSC supplied to the buffer circuit 111 is tuned high during the interval when the strobe signal STB is at high level. During the period when the control signal SSC is at high level, the gate of the output transistor MP8, and the phase compensation capacitor C1 are coupled to the power supply voltage VDD, and the gate of the output transistor MN8, and the phase compensation capacitor C2 are coupled to the power supply voltage VSS.

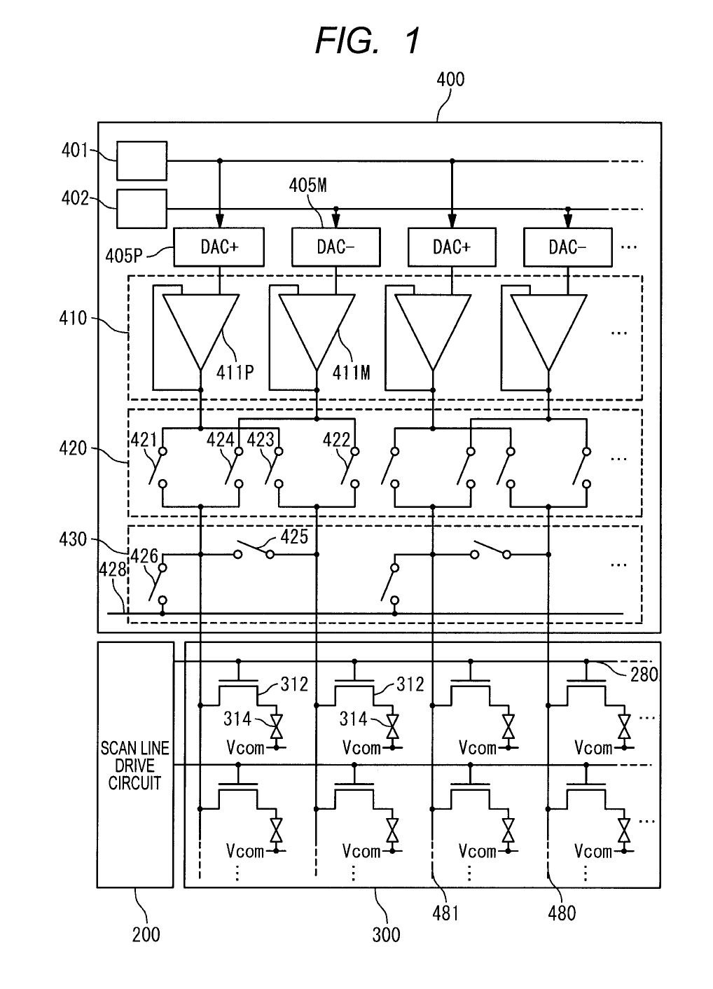

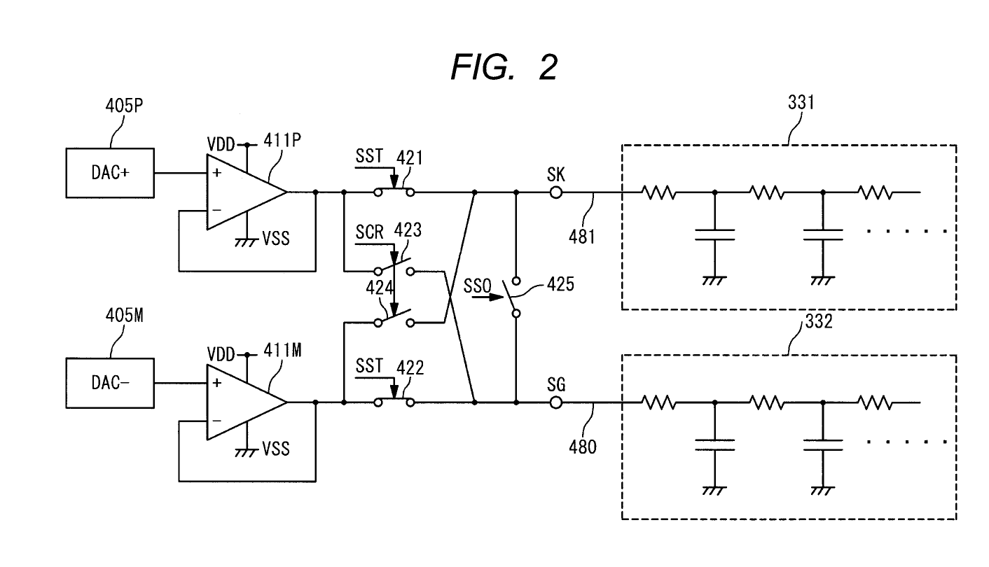

Further, as shown in FIG. 7E, the control signal SSD supplied to the buffer circuit 111 is opposite in phase to the strobe signal STB, and is tuned high during a period when the strobe signal STB is at low level. The switches SW5 to SW8 are turned on during a period when the control signal SSD is at high level. Accordingly, during the period when the strobe signal STB is at low level, the switches SW1 to SW4 are in the off state, and the switches SW5 to SW8 are in the on state, whereupon an output of the adder circuit of the buffer circuit 111 is supplied to the output circuit, and an output signal according to an input is outputted from the output circuit. During the period when the strobe signal STB is at high level, the switches SW1 to SW4 are in the on state, and the switches SW5 to SW8 are in the off state, whereupon the output circuit (the transistors MP8, MN8, and the phase compensation capacitors C1, C2) of the buffer circuit 111 is cut off from the adder circuit. Since the output transistors MP8, MN8 each are turned off, the output of the buffer circuit ill is in high impedance state, and furthermore, the switches 121 to 124 for coupling the buffer circuit 111 to the odd data line 181, and the even data line 182, respectively, are all closed, the odd output node SK, and the even output node SG will be at an identical voltage (FIGS. 7F and 7G). This period when the strobe signal STB is at high level is a period for the charge-sharing operation. Thus, the charge-sharing operation can be implemented without use of the short circuit switch 425 (refer to FIGS. 1, and 2), which used to be required for carrying out the charge-sharing operation.

By causing the buffer circuit 111 to turn into the high impedance state, the buffer unit 110 is cut off from the switching unit 120, and at the same time, the switches 121 to 124 are all closed, so that the odd output node SK is shorted to the even output node SG, adjacent to the odd output node SK, and the display panel load 331 coupled to the odd output node SK is shorted to the display panel load 332 coupled to the even output node SG. The multiple data lines in pairs to be shorted are shorted to the common node 128 via the common node connection switch 126 (refer to FIG. 4).

As described in the foregoing, with the output of the buffer circuit 111 kept in the high impedance state, and the switches 121 to 124 concurrently in the closed state, short-circuiting between the data lines adjacent to each other is implemented. By so doing, it is possible to completely dispense with the short circuit switch 425 for use in charge-sharing, as shown in FIG. 1. Further, it is possible to design such that on-resistance of the respective switches 121 to 124 upon concurrent closing is rendered equivalent to, or less than that of the short circuit switch 425 for use in charge-sharing without impairing functions of the individual switches 121 to 124. For this reason, such a configuration as described has no adverse effect from a standpoint of the charge-sharing operation, and is advantageous in terms of layout area to an extent that the short circuit switch 425 for use in charge-sharing is omitted.

Further, it is to be pointed out that the buffer circuit 111 be not limited to the configuration described as above, and it need only be sufficient to be able to cause the output of the buffer circuit 111 to be held in the high impedance state on the basis of the control signals SSC, SSD. Further, the output node OUT of the buffer circuit 111 is preferably fixed at a predetermined voltage such as an intermediate voltage between the power supply voltages VDD, VSS, and so forth on the basis of the control signals SSC, SSD.

While the present invention has been described with reference the embodiment thereof, it is to be understood that the present invention be not limited thereto, and that various modifications to the configuration of the invention and so forth will occur to those skilled in the art within the spirit and scope of the present invention.

What is claimed is:

1. A liquid crystal display drive circuit comprising:
a first buffer circuit for driving a first data line or a second data line adjacent to the first buffer circuit;
a second buffer circuit for driving the second data line, or the first data line;
a first switch to be closed so as to cause the first buffer circuit to drive the first data line in response to a first control signal generated on the basis of a strobe signal for indicating a timing reference for a display action:
a second switch to be closed so as to cause the second buffer circuit to drive the second data line in response to the first control signal;
a third switch to be closed so as to cause the first buffer circuit to drive the second data line in response to a second control signal generated on the basis of the strobe signal; and
a fourth switch to be closed so as to cause the second buffer circuit to drive the first data line in response to the second control signal; and
a control signal generation circuit for generating the first control signal, the second control signal, and a third control signal for causing respective outputs of the first buffer circuit, and the second buffer circuit to be in a high impedance state on the basis of the strobe signal.

2. The liquid crystal display drive circuit according to claim 1, wherein the control signal generation circuit generates the first and second control signals such that the first to fourth switches are closed when the respective outputs of the first buffer circuit, and the second buffer circuit are turned into the high impedance state in response to the third control signal.

3. The liquid crystal display drive circuit according to claim 1, further comprising a fifth switch for coupling the first data line, and the second data line to a common node when the respective outputs of the first buffer circuit, and the second buffer circuit are in the high impedance state.

4. The liquid crystal display drive circuit according to claim 1, wherein the first buffer circuit, and the second buffer circuit each comprise an output transistor to be turned OFF by causing short-circuiting between the gate, and the source thereof.

5. The liquid crystal display drive circuit according to claim 4, wherein the first buffer circuit, and the second buffer circuit each comprise a phase compensation capacitor having one end coupled to an output node, and the other end coupled to an output of a preceding stage, and when the respective outputs of the first buffer circuit, and the second buffer circuit are in the high impedance state, the other end is coupled to a predetermined power supply voltage in response to the third control signal.

6. A method for driving a liquid crystal display, comprising the steps of:
(a) coupling an output of a first buffer circuit to a first data line, and coupling an output of a second buffer circuit to a second data line in response to a first control signal;
(b) coupling the output of the first buffer circuit to the second data line, and coupling the output of the second buffer circuit to the first data line in response to a second control signal; and
(c) causing the respective outputs of the first buffer and second buffer circuits to be turned into high impedance state when the respective outputs of the first and second buffer circuits are coupled to both the first and second data lines,
wherein there is executed a charge-sharing operation whereby the respective voltages of the first and second data lines, adjacent to each other, are at a common voltage when the respective outputs of the first and second buffer circuits are in the high impedance state.

7. The method for driving a liquid crystal display, according to claim 6, further comprising the step of coupling the first data line, and the second data line to a common node when the respective outputs of the first and second buffer circuits are in the high impedance state.

8. The method for driving a liquid crystal display, according to claim 6, wherein the first buffer circuit, and the second buffer circuit each comprise an output transistor, and the step of causing the respective outputs of the first and second buffer circuits to be turned into high impedance state, includes a step of causing short circuit between the gate, and the source of the output transistor to be thereby turned off.

9. The method for driving a liquid crystal display, according to claim 6, wherein the first buffer and the second buffer circuits each comprise a phase compensation capacitor having one end coupled to an output node, and the other end coupled to an output of a preceding stage, and the step of causing the respective outputs of the first and second buffer circuits to be turned into the high impedance state, includes a step of coupling the other end to a predetermined power supply voltage.
